(19) United States
(12) Patent Application Publication
(10) Pub. No.: US 2011/0045165 A1
(43) Pub. Date: Feb. 24, 2011

(54) SYSTEM AND METHOD OF DETERMINING POINT SOURCES OF WATER INFILTRATION/INFLOW INTO A SEWER SYSTEM

(76) Inventor: Gene Rigby, Marion, OH (US)

Correspondence Address: ELEY LAW FIRM CO., 7870 OLENTANGY RIVER RD, SUITE 311, COLUMBUS, OH, 43235, US

(21) Appl. No.: 12/859,696

(22) Filed: Aug. 19, 2010

Related U.S. Application Data
(60) Provisional application No. 61/235,206, filed on Aug. 19, 2009.

(51) Int. Cl. B32B 43/00; B05D 1/00; B05C 11/00

(52) U.S. Cl. 427/8; 118/712

(57) ABSTRACT

A system for identifying the point source of external fluid infiltrating into a sanitary sewer system. An apparatus applies a substantially uniform coating to the surface of inner walls of a portion of the sewer system. The system also includes means for observing and recording the initial condition of the coated surface, means for observing and recording subsequent conditions of the coated surface, and means for comparing the initial condition of the coated surface with subsequent conditions to detect a predetermined change in the condition of the coated surface. The change in the condition of the coated surface indicates the point source of the infiltration of water into the sewer system.

This application claims priority to U.S. provisional application 61/235,206, filed Aug. 19, 2009, the entire contents of which are hereby incorporated by reference thereto.

### FIELD

The present invention relates generally to a method of determining water leakage, in particular to a method of determining groundwater leakage into buried pipe and underground manholes.

### BACKGROUND

Groundwater leakage into a sanitary sewer system is not desirable. When ground water infiltrates the sanitary sewer system, the sewer treatment system may become overtaxed since it now must handle extra water that does not generally need to be treated. This leads to wasteful increases in processing costs, equipment costs and the potential that sewage at the treatment facility may prematurely overflow into the environment, prior to being fully treated.

Groundwater infiltration/inflow (“I/I”) may result from a number of events, such as heavy rains, locally or remotely (upstream), flooding, melting snow/ice, and water line breaks, hereinafter referred to as “water events.” In this context, ground water is not necessarily emanating from the ground, but rather it is filtering through the ground into the sewer system. This water will be drawn by gravity to its lowest point, generally a sanitary sewer system, if available. The source of I/I into the sanitary sewer system is generally known and can be pinned down to a number of major contributors.

One such source is I/I into a sanitary sewer manhole at points where sewer pipes enter and exit the structure or through cracks along the walls of the manhole. Since the sewer pipe may be open where it passes through the manhole, any groundwater that infiltrates the manhole will pass into the sanitary sewer lines for subsequent transmission to the treatment facility.

Another source of I/I into a sewer system is via cracks in the walls of buried sanitary sewer lines themselves. In either case, following a water event, ground water will follow the gravitational path of least resistance which often includes cracks or leaks in the sanitary sewer subcomponents (manholes and buried pipes).

Currently, locating these costly leaks relies much on happenstance, i.e., such as someone being in the right manhole during active I/I. However, humanly observed I/I occurrences are rare and may continue unabated for years before detected, if ever.

If an I/I leak is detected it may be readily repaired in a number of conventional means, such as by grouting/regrouting, surface coatings, resurfacing, replacing of a faulty pipe or other, suitable remedial measures. The challenge facing sewer maintenance personnel is the timely detection of a leak, which usually occurs only after a water event. Adding to the detection problem is the timing, as some leaks may not occur until days following the water event because of the distance from the event and other factors. What is needed is a simple system and method for indicating the source(s) of I/I into the sanitary sewer system that will continue to indicate the I/I for some time afterward to eliminate the need to be physically present at the time the I/I is occurring.

### SUMMARY OF THE INVENTION

The system and method described herein provides a means to determine if buried sewer pipe or structure (i.e., a manhole) in a sanitary sewer system suffers from I/I without requiring a physical presence to observe the I/I event in real time.

In one embodiment this is accomplished by applying preparing the inner surface of pipe/structure and then coating the surface with an indicia material that is compatible with the surface area to be coated, which is environmentally safe and which provides a lasting or temporal indication as to whether it has been impacted upon by a subsequent I/I event. The indicia consists of a flowable coating material which exhibits physically observable characteristics that may include staining/discoloration of the impacted area or a washing away of all or a portion of the coating that has been impinged upon.

The process comprises preparing the surface to be coated by removing environment elements such as dirt, scum, sediment and the like to produce an adherable surface. Next, a suitable coating is applied to the inner surface of the pipe/structure and is permitted to dry. Following application of the coating to a select inner surface of a portion of the sanitary sewer system, a baseline record may be made either by physical examination or via video means to produce a “before” condition. Water events that are likely to cause I/I into the coated area are monitored and then the coated area is subsequently observed to determine whether the coating has been discolored or washed away by groundwater during the I/I event, the “after” condition. The observation of the coated area may need to be repeated several times and the results of each observation recorded in order to determine the source and, potentially the magnitude, of the I/I. Recordation may comprise visual inspection and written reporting of the coated surfaces, photographing and time stamping the visual inspections, videotaping and time logging the inspections, or any combination thereof.

Utilizing the disclosed system and methodology enables one to determine the point of the I/I, estimate the volume and/or quantify the severity of the leak by the amount of impact on the indicating coating. This enables a maintenance department to selectively and efficiently apply repairs to only those structures in need rather than sealing or replacing an entire length pipe or structure, thus providing for a significant savings resources while greatly contributing to maintaining the integrity and efficiency of the sewage treatment system as a whole.

### BRIEF DESCRIPTION OF THE FIGURES

Further features of the inventive embodiments will become apparent to those skilled in the art to which the embodiments relate from reading the specification and claims with reference to the accompanying figures, in which:

FIG. 1 is a schematic view of an aspect of the present disclosure depicting the application of a coating to the inner surface of a sewer pipe;

FIG. 2 is a flow diagram depicting a method for detecting point sources of I/I in a sewer system; and

FIG. 3 is an elevational view of an inner wall of a manhole that is partially coated with an indicative coating and showing the I/I event occurring in real-time around the underside of the sewer pipe/manhole junction

### DETAILED DESCRIPTION

External sources of water entering a sanitary sewer system referred to as Infiltration/Inflow (I/I) is problematic worldwide. When this occurs, the sanitary sewer collection system losses capacity, sewers hydraulically back up into customers residences and businesses, and the system often overflows untreated sewage directly into waterways prior warning. This is due to the treatment system trying to treat much more water than its intended design capacity. This is a worldwide problem, specifically as our infrastructure ages and the sewer systems become more porous to the environment.

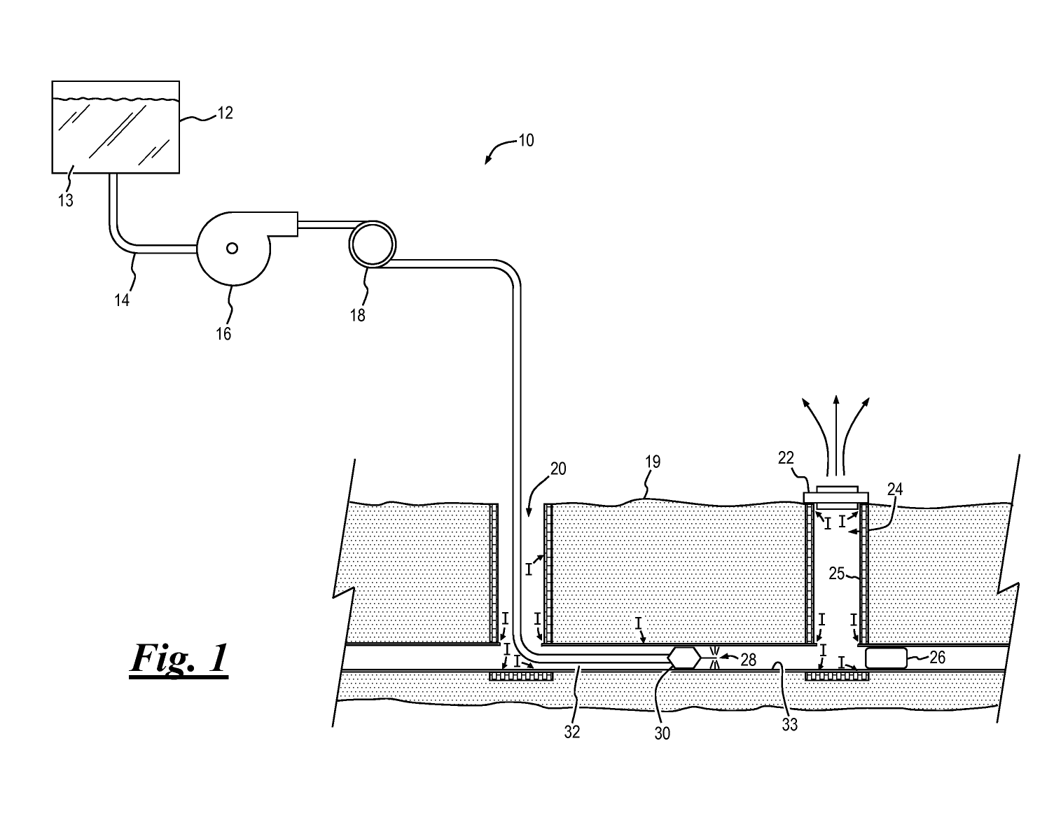

Referring to FIG. 1, a portion of a sanitary sewer system is shown, comprising gravity sewer main lines (not shown), manholes (junction points or maintenance access points), as at 20 and 24 and gravity sewer lateral lines (individual lines servicing a single point), as at 32, pump stations (not shown) and force main lines (not shown). Force main lines are typically an exfiltration problem and are not the topic of this disclosure. The majority of the remainder of the sewer system, including sewer lines 32 and manholes 20, 24, is buried beneath the surface of the ground 19 and is susceptible to groundwater (infiltration) or surface water (inflow), that is I/I, flowing into them. These multiple potential points of infiltration are illustrated in FIG. 1 as points labeled “I”.

The prior art method of relying solely on visual identification of points of I/I into a sanitary sewer system are difficult to perform, time consuming and expensive. On example of finding defects in sewer pipe are disclosed in U.S. Pat. No. 4,373,381, issued to Kulp et al. This process requires sealing off the incoming pipes and performing a vacuum test on the manhole. Another involves the process of installing a plug between two sections of pipe and then pressure testing the section of pipe, as disclosed in U.S. Pat. No. 5,467,640, issued to Salinas.

The method disclosed herein provides a simple means of applying a water responsive coating to surface portions of a sewer system, as at 25, 33, proximal suspected areas of I/I. The coating may be applied to the inner wall 33 of sewer pipe 32 using a coating system 10, as shown in FIG. 1. A coating reservoir 12 stores a select coating material. The flowable coating material 13 is formulated to have suitable surface adherence and water responsive properties given a particular environment in which it is to be applied. Coating material is supplied to coating pump 16 via supply line 14. Hose reel 18 is provided in order to keep proper tension on the supply line as it is fed into the manhole 20, through sewer line 32 and eventually to centering cage (or “pig”) 30 for dispensing the coating 13 on the inner surface 33 of the sewer line. Subsequent observations of the coated inner surface 33 may be conducted without having to enter the sewer manhole 29 by using a remote camera and/or video system (not shown, but widely known).

In another embodiment, particularly suitable for coating select inner wall 25 of a manhole 24, a spray coating system may comprise a hand-held portable sprayer, such as a pressurized spray can (not shown). The coating 13 can then be applied manually to inner wall 25 by an operator located within or in close proximity to manhole 24. When applying the coating 13 manually, a template, such as a square or rectangular stencil (not shown) may be employed to achieve a uniform pattern in the initial coating to the inner wall 25 of manhole 24.

It is not practical to be present during an I/I event to observe via sewer camera where the I/I is occurring. Typically groundwater or rainwater entering the sanitary sewer system does not discolor the surface of the structure long enough to leave a permanent indication of the source of the I/I. To simulate a water event large enough to trigger I/I into a sewer system requires a significant volume of water to be injected into the ground.

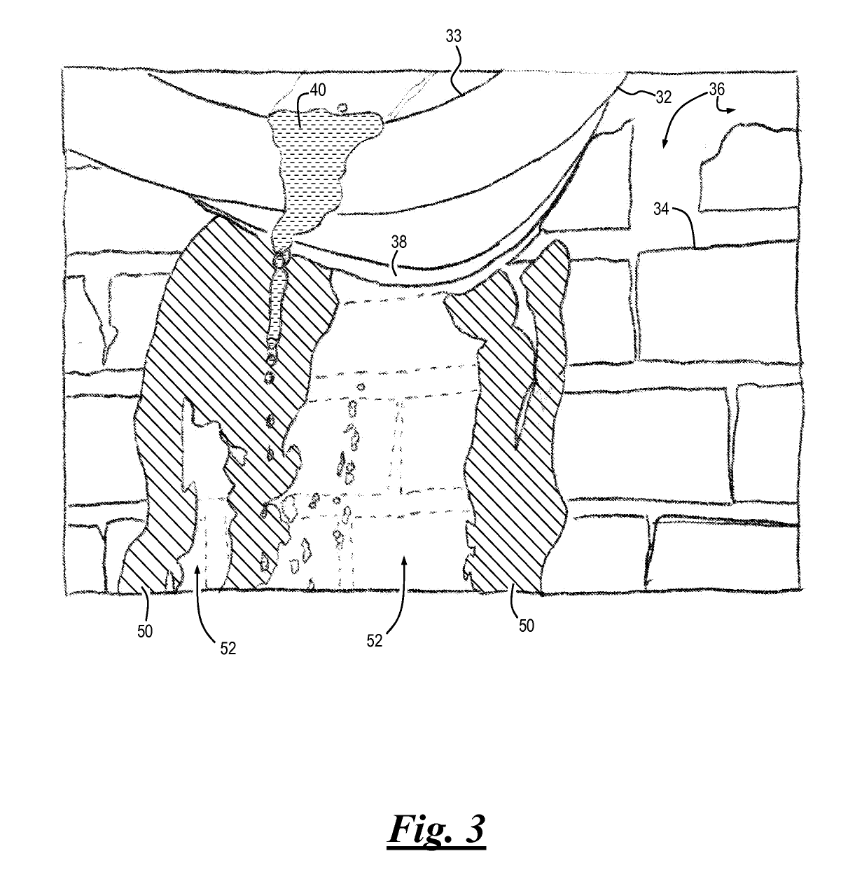

The selected coating material 13 is formulated to adhere to the structural surface to be tested. In one embodiment, the selected coating material 13 needs to adequately adhere, but yet not bond to the structural material so that it may be flushed out of the system at a later time. In application where the I/I involves a low velocity flow of water the coating material 13 preferably responds to contact with the water by changing color or hue, but not remove it entirely. If the I/I involves a higher velocity flow then it may be desirable to formulate the coating material 13 so that it is removed from the coated surface entirely. This effect can be seen in FIG. 3, wherein coating material 50 applied beneath a sewer line 32 to the inner wall of a manhole, as at 25, is washed away from the surface, as depicted by washed area 52, as the result of I/I coming from under the sewer line at gap 38. It is preferable that the select coating material 13 is formulated such that its change of color or hue in response to its contact with water lasts for an extended period, such as a week or more, to enable inspection of the coated surface areas for some duration following a water event to determine the point source(s) of I/I.

The select coating material 13 is formulated as necessary to adhere to a variety of structural materials such as, but not limited to, pre-cast concrete, ceramic brick and mortar, masonry brick 34 or block/mortar 36, fiberglass, plastics (PVC or HDPE), limestone/mortar or ceramic clay. The structural material may be lined with concrete, epoxies, fiberglass or sectionalized PVC or HDPE.

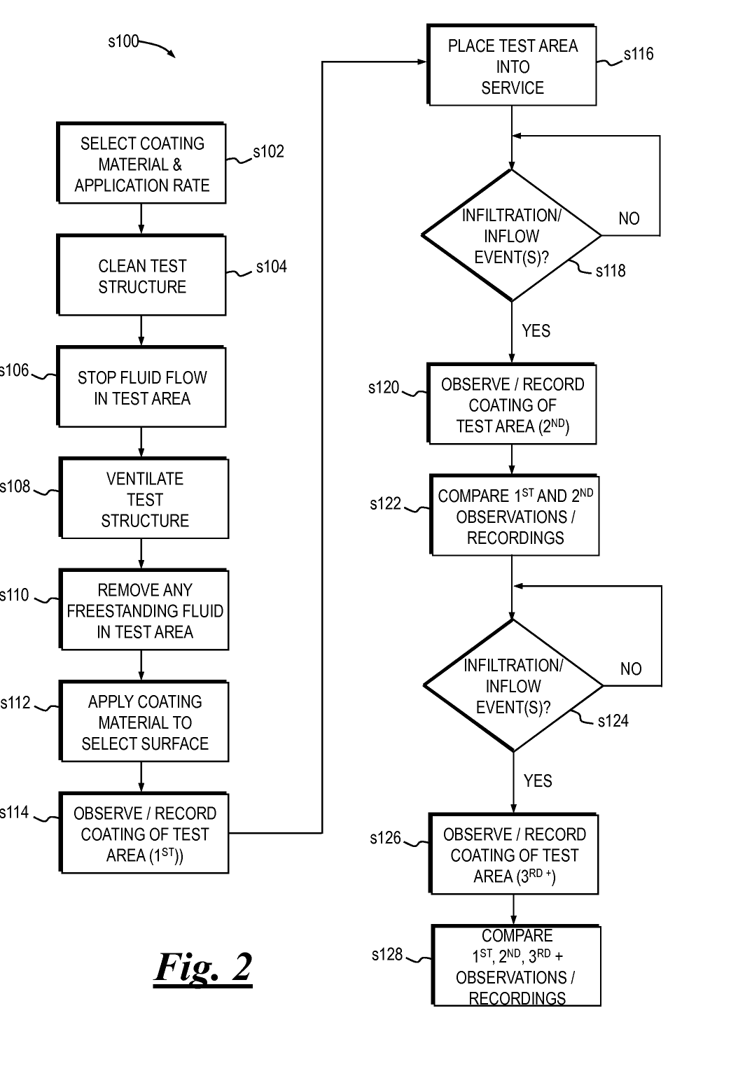

Referring now to FIG. 2, a process for determining the point sources of I/I is described at s100. Firstly, a suitable coating is selected at step s102. The selected coating material will have the adhesion, viscosity and water responsive properties that are preferably optimized for a given surface upon which it is to be applied. Once the proper coating material has been selected, the surface upon which it is to be applied is cleaned of surface debris and coatings, such as slime, mold, sediment and the like as step s104. Flow of any materials through sewer line 32 is blocked off at step s106 to enable coating of the entire select surface. Once cleaned and free from continued flow of materials, the area to be tested for I/I is ventilated at step s108, such as with a fan 22 (FIG. 1) in order to have a dry surface area to improve adhesion. In addition, any remaining fluids in the selected test area are removed at step s110. After the surface has been prepared, a select coating material is applied to the select inner surface of the sewer system component in proximity to the suspected source of the I/I, as at step s112. The coating material may be applied by either a machine or by an operator, manually. Following application of the coating material, the initial condition of the coating is observed and recorded as at step s114. This step may be done manually and recorded in a report; utilize photographic or video methodology, or any combination thereof.

After the recordation of the initial coating condition, the sewer line 32 is placed back into service, as at step s116, by removing all blockages and opening any previously shut off valves. The operator then awaits for a suitable water event at step s118, sufficient to cause I/I. Following such an event the condition of the coated surface is once again observed and recorded, as before in step s114. The subsequent observation is then compared to the initial observation for changes in the pattern of applied coating material or any change in its color or hue. If changes are detected, then the point source of I/I may be readily identified as at step s124. If not, the observation process is repeated, as at steps s126 and s128 until there is evidence of a change in the condition of the coating material. If, after numerous observations, no change is detected, then it may be concluded that no I/I is occurring at the point under test

The above description is for a process that allows a sewer system operator to locate and define the location of I/I entering into their sewer system composing of sewer main lines, manholes/structures and sewer laterals. The process also allows for estimating the quantity of I/I that occurred for one or more rain-I/I events. Compared to the alternative means of testing, it is a simpler, more cost effective method of locating I/I problems in a sewer system by enabling the determination of the presence or absence of I/I in a sewer lateral, both at the connection point and upstream of the connection point. The presently described disclosure also enables the sewer operator to determine the high flow level that occurred in the sewer main, manhole/structure and sewer lateral connection point by visually observing the color or hue of the coating material. With the use of currently-available video laser profiling equipment and digital imaging methods, the extent of a problem can be determined by measuring change in flow pattern, the level of flow, as indicated by the change in color or hue in a pipe or structure and the projected horizontal distance the groundwater flowed from the observed defect to another point in the structure.

While this invention has been shown and described with respect to several detailed embodiments thereof, it will be understood by those skilled in the art that various changes in form and detail thereof may be made without departing from the scope of the claims of the invention. One skilled in the art will recognize that many of the separately-described functions of the various embodiments of the present invention may be combined, rearranged or eliminated to accomplish the desired result without affecting the scope of the invention. The embodiments disclosed herein are for illustrative purposes only and are not intended to be limiting with regard to the arrangement or combination of the components of the present invention.

I claim:

1. A system for identifying the point source of external fluid infiltrating into a sanitary sewer system, comprising:
an apparatus for applying a substantially uniform coating to the surface of inner walls of a portion of the sewer system;
means for observing and recording the initial condition of the coated surface;
means for observing and recording subsequent conditions of the coated surface; and
means for comparing the initial condition of the coated surface with subsequent conditions to detect a predetermined change in the condition of the coated surface,
wherein the change in the condition of the coated surface indicates the point source of the infiltration of water into the sewer system.

2. A method for determining the point source of external water infiltrating into a sanitary sewer system following a water event comprising the steps of:
selecting a coating having a predetermined reaction when contacted by water and having suitable adherence properties to a select surface within the sanitary sewer system;
applying the coating to a select surface within the sanitary sewer system in an area proximal to a suspected point source of the infiltration;
observing the initial visual condition of the select coated surface;
monitoring water events that would likely lead to infiltration of external water onto the sanitary sewer system;
observing a subsequent condition of the select coated surface;
comparing the initial and subsequent observations of the select coated surface to determine whether there has been a change between the initial and subsequent observations of the select coated surface; and
determining the point source of infiltration of external water into the sanitary sewer system by observing a change in the condition of the select coated surface.
